(19) United States
(12) Patent Application Publication
(10) Pub. No.: US 2012/0011980 A1
(43) Pub. Date: Jan. 19, 2012

(54) QUICK-CHANGE SYSTEM FOR MEAT TRIMMER BLADES

(75) Inventor: ANDREAS KRÖGER, PADERBORN (DE)

(73) Assignee: FREUND MASCHINENFABRIK GMBH & CO. KG, PADERBORN (DE)

(21) Appl. No.: 13/034,265

(22) Filed: Feb. 24, 2011

(30) Foreign Application Priority Data
Jul. 15, 2010 (DE) 20 2010 008 081.9

(51) Int. Cl. B26D 7/26

(52) U.S. Cl. 83/698.41

(57) ABSTRACT

A quick-change system for blades of a meat trimmer, which is used as a cutting tool in the stripping or cutting of meat and the like, includes a handle with a connecting housing to which a ring-like blade holder is attached. A ring-like blade is held inside the blade holder and rotated by a driving gear. The connecting housing has arm-like projections on both sides, on which the blade holder is mounted and has a separation point between the projections. The ring-like blade holder is fixed to a projection in an operating position by the head of a releasable bolt. When the bolt is loosened, the blade holder is bent open from an operating position to a blade change position in which the ring-like blade can be changed without tools in a very short time, without the necessity of readjusting the blade holder after its return to the operating position.

### CROSS-REFERENCE TO RELATED APPLICATION

This application claims the priority, under 35 U.S.C. §119, of German Patent Application DE 20 2010 008 081.9, filed Jul. 15, 2010; the prior application is herewith incorporated by reference in its entirety.

### BACKGROUND OF THE INVENTION

### Field of the Invention

The present invention relates to a quick-change system for blades of a meat trimmer, which is used as a cutting tool in the cutting or stripping of meat and the like. The system includes a handle with a connecting housing to which a ring-like blade holder is attached. A ring-like blade is held inside the blade holder and rotated by a driving gear. The connecting housing has arm-like projections on both sides, on which the blade holder is mounted and has a separation point between the projections.

Today, carcasses are mostly cut or stripped industrially, individually and by hand. A hand tool often required by carcass cutting companies is a meat trimmer with a ring-like blade. The blade is driven by either a pneumatic or an electric actuator and it provides optimal support for the user, so that a clean and quick controlled cut is possible. The trimmer technology allows cuts, which when carried out with a conventional manual blade are very cumbersome, and thus optimizes the yield. At the same time, the cut is more even than that of a normal manual blade.

A generic hand-held meat trimmer, which is known from U.S. Pat. No. 4,575,938, has a ring-like blade for trimming meat, in which the blade is rotatably mounted on a blade holder, which is mounted on a frame with a handle. The frame includes a pair of arcuate shaped arms, on which the blade holder is secured by a pair of attachment bolts. One of the arms is integrated in the frame and the other is removably secured by a locking collar. The blade holder is sufficiently elastic or resilient, so that the fixation of the locking collar can be released and the detachable arm can be expanded outwardly from the remaining portion of the frame, allowing the blade to be removed from the expanded blade holder and to be replaced. The blade holder is attached to the frame with attachment bolts, wherein one of the bolts engages in an oblong recess of the blade holder, and in that way also serves to adjust its diameter. The structure for adjusting the blade holder and changing the ring-like blade, as described above, is complicated and cumbersome.

U.S. Pat. No. 4,854,046 discloses another meat trimmer, which includes a driven rotating ring-like blade in a ring-like housing on a handle. That meat trimmer is equipped with a retainer for holding the blade in such a way that it is retained by a pivoted arcuate-shaped clamp with a beveled inner edge. The blade can be removed by loosening a nut and pivoting the clamp. The disadvantage thereof is the complicated construction including many parts. It is easily soiled with slaughter products, and thus the meat trimmer requires relatively frequent cleaning. Thus, the construction of the device is disadvantageous from an operational hygiene point of view. In addition, the swivel joint on which the clamp is pivoted projects into the cutting area of the meat trimmer, so that it is not freely accessible which limits both-sided usability.

### SUMMARY OF THE INVENTION

It is accordingly an object of the invention to provide a quick-change system for meat trimmer blades, which overcomes the hereinafore-mentioned disadvantages of the heretofore-known devices of this general type due to a construction that is favorable for cleaning, in which a ring-like blade can be removed and changed quickly and easily without tools.

With the foregoing and other objects in view there is provided, in accordance with the invention, a quick-change system for blades of a meat trimmer used as a cutting tool in the cutting or stripping of meat and the like. The system comprises a handle with a connecting housing, the connecting housing having two sides and arm-shaped projections each disposed at a respective one of the sides, a ring-shaped blade holder attached to the connecting housing by mounting at the projections, the blade holder having a separation point between the projections, a ring-shaped blade guided in the blade holder and driven to rotate by a driving gear, and a releasable bolt having a head fixing the blade holder to one of the projections in an operating position of the blade holder. The blade holder is configured to be bent open from the operating position to a blade change position upon loosening the bolt, permitting the blade to be changed quickly without tools and without readjusting the blade holder after returning the blade holder to the operating position.

The invention is therefore based on a meat trimmer, the handle of which includes an arcuate-shaped connecting housing, to which a ring-like blade holder is attached. A ring-like blade is guided in the blade holder, which is rotated through a driving gear. The connecting housing has arm-like projections on both sides, on which the blade holder is mounted. The holder has a separation point between the projections, which allows bending open the blade holder.

The meat trimmer is fitted with a quick-change system for the blade in such a way that the blade holder is fixed to a projection of the connecting housing in an operating position by the head of a releasable bolt. When the bolt is loosened, the blade holder is bent open from an operating position to a blade change position in which the ring-like blade can be changed without tools in a very short time, without the necessity of readjusting the blade holder after its return to the operating position.

The construction of the bolt is such that it has a head at its one end and is threaded at its other end. The bolt head fixes the ring-like blade holder next to the separation point to a projection of the connecting housing. It engages in a recess having the size of the bolt head. In this way, the blade holder is maintained in an operating position and it is not necessary to readjust the blade holder after a blade change.

Since the bolt is positioned outside of the cutting area, the blade is freely accessible for use. A knurled nut according to German Industrial Standard DIN 466 is screwed onto the threaded portion of the bolt. When the knurled nut is loosened, the bolt is released in such a way that the ring-shaped blade holder bends open into the blade change position. Thus, the blade can advantageously be taken out of the blade holder and be exchanged with another blade without tools in a very short time.

The bolt passes through an opening in the projection in such a way that the knurled nut is located on the outside of the connecting housing. The bolt head and the nut are both positioned in a recess of the projection to provide a space-saving and hygienic construction. It is particularly advantageous to construct the quick-change system from few components in an easy-to-clean implementation, which optimally supports an operational hygiene concept and requires a minimum number of spare parts, thus reducing operating costs.

The blade holder is fixed with a fastening screw which is screwed into a threaded socket of the projection, at the other projection of the connecting housing. For the purpose of a space-saving and hygienic construction, the fastening screw is also positioned in a recess. This screw also permits adjustment of the size of the blade holder in the operating position.

The blade holder partially has a wider profile, through the use of which it is held in an inner holding groove of the connecting housing and the projection on both sides, for the purpose of stabilizing the blade holder.

The blade holder is preferably made of an elastic or resilient metal such as spring steel or the like, which can be deformed up to a certain elastic limit, specific to the material, and then elastically or resiliently returns to the initial state without permanent deformation. Preferably, the blade holder can yield under stress like a spring with a spiral and after discharge return to the original shape. Any further displacement leads to plastic deformation.

The blade is driven by a pinion, which is connected to an external drive unit by a flexible drive shaft, or alternatively is directly driven by an internal electric motor or pneumatic motor in the handle. In an embodiment of the invention, the pinion is located inside the connecting housing, which is closed by a cover, so that safe handling of the meat trimmer is guaranteed.

The blade is shaped as a ring, with a gear rim on the outer perimeter and with a cutting edge on the inside. The teeth of the pinion engage in the gear rim of the blade for driving, so that it rotates with a relatively high speed. The inner cutting edge of the rotating blade permits even cuts with a higher productivity to be performed in carcass cutting.

The profile of the blade exhibits a concave inner surface, on which the slaughter product is cut, and a convex outer surface, which forms an outer circumferential guiding groove below the gear rim. Correspondingly, the ring-like blade holder forms an inner circumferential guiding tongue. Preferably, the guiding tongue and the guiding groove engage in such a way that the blade is securely held in the blade holder.

On the other hand, bending open the blade holder when releasing the bolt separates the guiding tongue from the guiding groove, so that the blade can easily be removed and another blade of the same construction can be used.

Other features which are considered as characteristic for the invention are set forth in the appended claims.

Although the invention is illustrated and described herein as embodied in a quick-change system for meat trimmer blades, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a diagrammatic, perspective view of a meat trimmer with a quick-change system;

FIG. 2 is a top-plan view of the meat trimmer with the quick-change system;

FIG. 3 is a perspective view of a connecting housing showing the inside thereof;

FIG. 4 is a side-perspective view of the connecting housing showing the outside thereof;

FIG. 5 is a fragmentary, cross-sectional view of the connecting housing, which is taken along a line B-B of FIG. 4, in the direction of the arrows;

FIG. 6 is a cross-sectional view of the quick-change system, which is taken along a line A-A of FIG. 2, in the direction of the arrows;

FIG. 7 is a top-plan view of a ring-like blade holder;

FIG. 8 is a cross-sectional view of the blade holder, which is taken along a line C-C of FIG. 7, in the direction of the arrows;

FIG. 9 is a top-plan view of a ring-like blade;

FIG. 10 is a cross-sectional view of the blade, which is taken along a line D-D of FIG. 9, in the direction of the arrows; and

FIG. 11 is an enlarged, fragmentary, cross-sectional view of a portion E of the blade shown in FIG. 10.

### DETAILED DESCRIPTION OF THE INVENTION

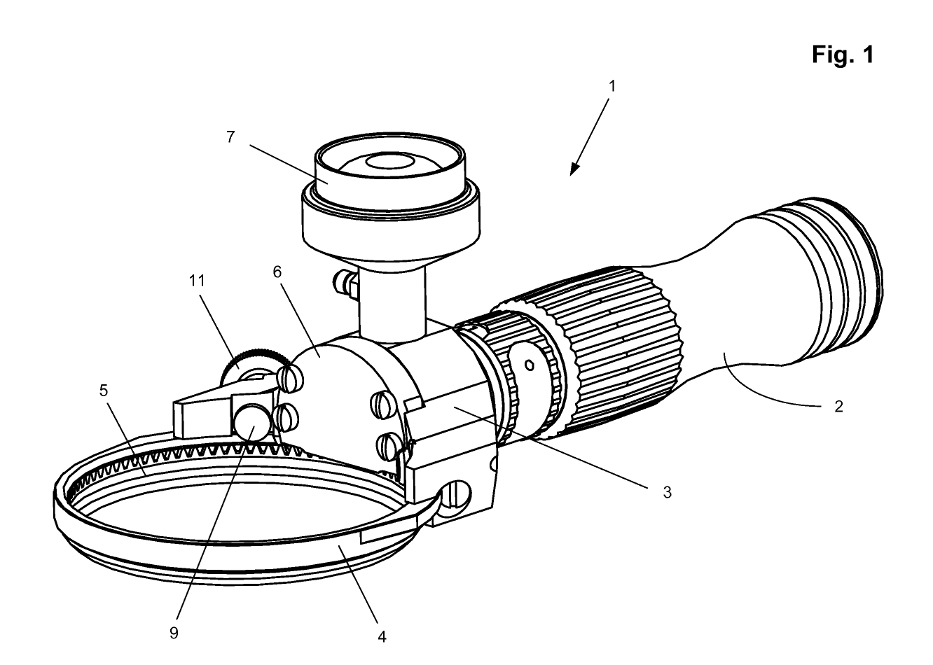

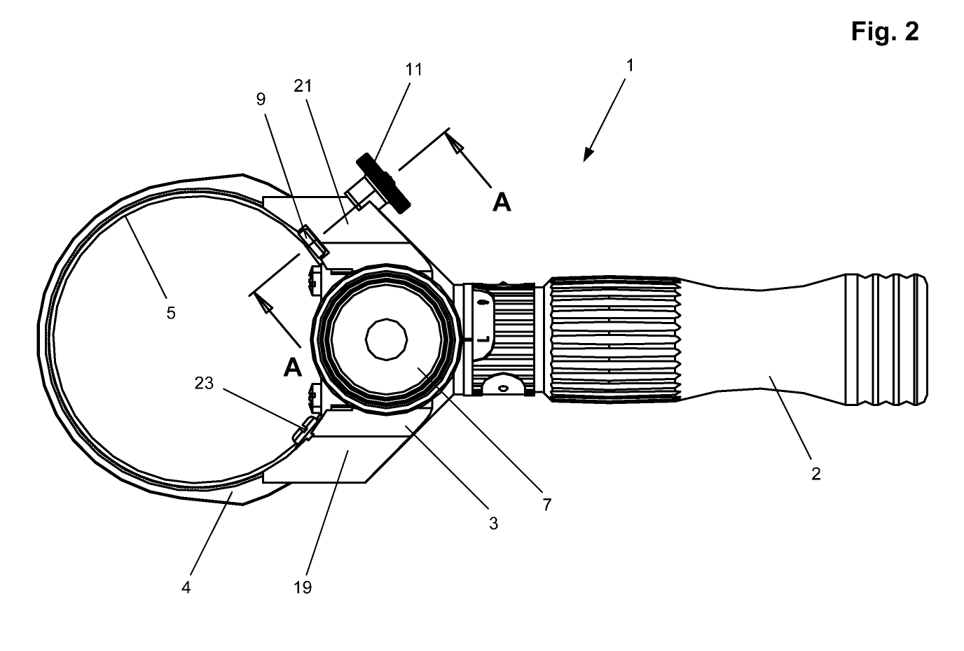

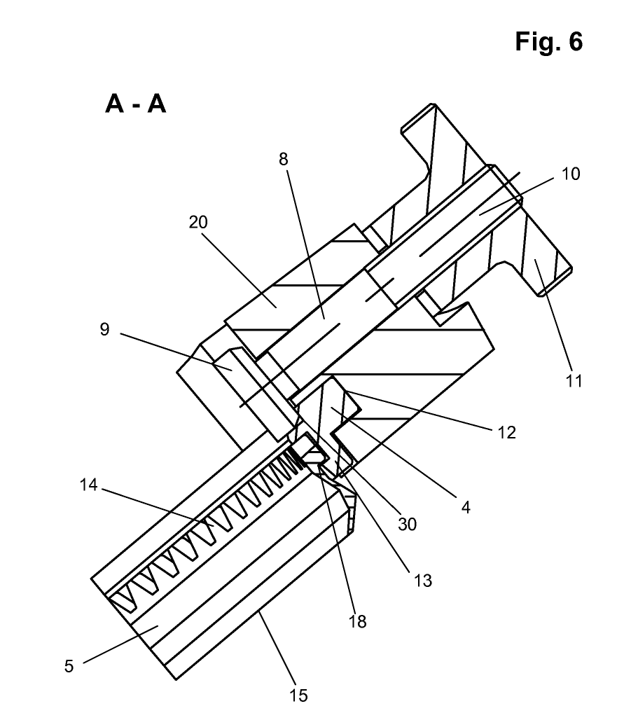

Referring now to the figures of the drawings in detail and first, particularly, to FIGS. 1 and 2 thereof, there is seen an embodiment of a meat trimmer 1 with a quick-change system according to the invention, which is presented in detail. The meat trimmer 1 includes a handle 2 with an arcuate-shaped connecting housing 3 at its front end, to which a ring-like blade holder 4 is attached. A ring-like blade 5 is guided in the blade holder 4, and is rotated by a driving gear. The gear in this case is a pinion, which is connected to a drive unit by a flexible drive shaft, or a similar driving device. In this case, the pinion is located inside the connecting housing 3, behind a cover 6, and engages in a gear rim 14 (see FIGS. 6, 10 and 11) of the ring-like blade 5 for driving. Lubrication for the meat trimmer 1 is provided by a grease reservoir 7. In this representation, a bolt head 9 and a knurled nut 11 of the quick-change system according to the invention are visible.

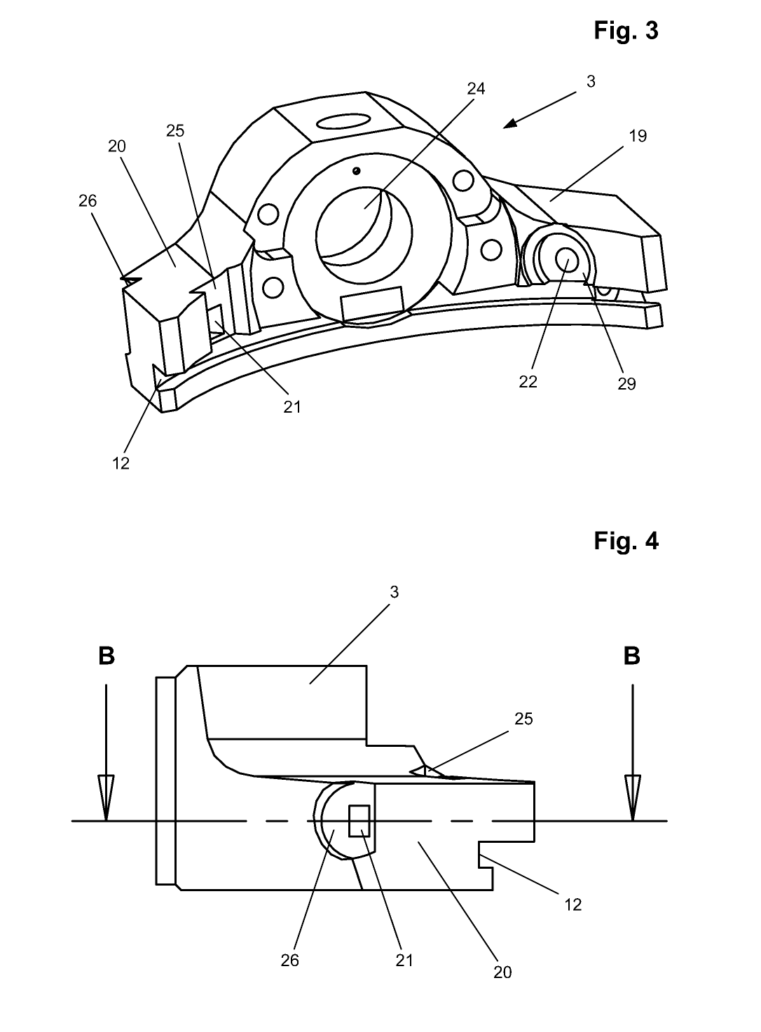

The connecting housing 3, as shown in FIG. 3 and FIG. 4, includes two arm-like projections 19 and 20, which extend in an arch on both sides of the connecting housing 3 and encompass the ring-like blade holder 4. The blade holder 4 is fixed to the projection 19 with a fastening screw 23 which is screwed into a threaded socket 22, and is situated in a recess 29. The projection 20 has an opening 21, through which a bolt 8 extends with a bolt head 9, as seen in FIG. 6. The bolt head 9 is positioned in a recess 25 and the knurled nut 11 is positioned in a recess 26. A size of a recess 30 seen in FIG. 6 corresponds to a size of the bolt head 9 and thus the bolt head fits precisely into the blade holder 4.

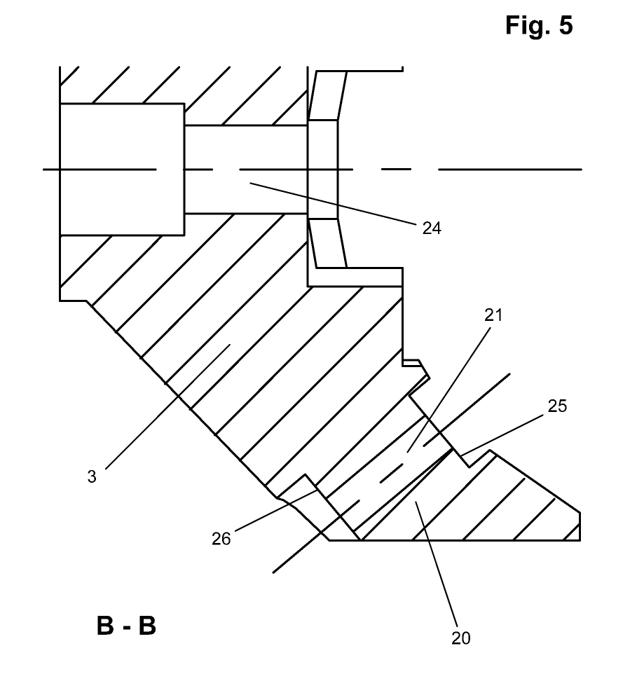

The connecting housing 3 has a central opening 24 for the pinion. Furthermore, a lower end of the connecting housing 3 and the two projections 19 and 20 include a continuous holding groove 12 for the blade holder 4 so that the blade 5, which rotates at a relatively high speed, can be moved steadily through the slaughter product, and safe handling is ensured. FIG. 5 shows the projection 20 with the opening 21 for the bolt 8, as seen along a section line B-B in FIG. 4.

FIG. 6 shows details of the quick-change system according to the invention, as seen along a section line A-A in FIG. 2. As described with regard to FIG. 5, the bolt 8 extends through the projection 20 of the connecting housing 3 in such a way that the bolt head 9 is positioned in the recess 30 at the inside of the blade holder 4. The opposite end of the bolt 8 has a thread 10, onto which the knurled nut 11 is screwed. The blade holder 4 is maintained in the holding groove 12 at the inside of the projection 20. An inner surface of the blade holder 4 is shaped in such a way that a circumferential guiding tongue 13 is formed at the inside on one axial end, which engages in a circumferential guiding groove 18 on the outside of the blade 5 in a form-locking connection, so that the rotating blade is securely guided. A form-locking connection is one which connects two elements together due to the shape of the elements themselves, as opposed to a force-locking connection, which locks the elements together by force external to the elements.

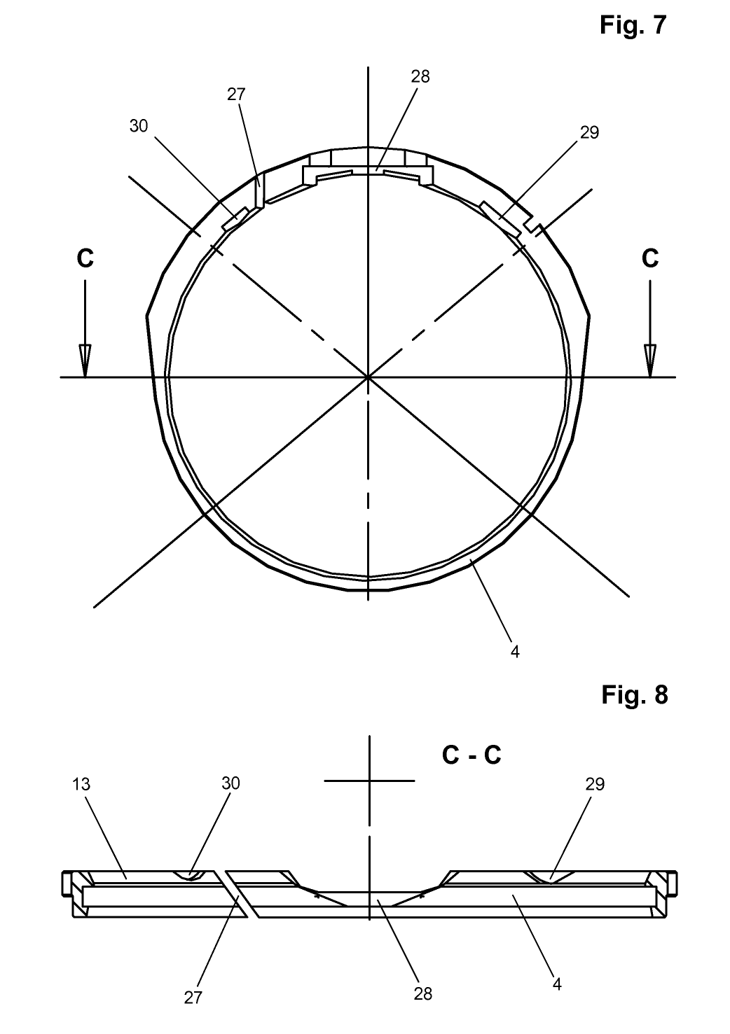

The blade holder 4, as shown in FIG. 7 and FIG. 8, is ring-shaped and has an axially widened portion, which supports the blade holder 4 in the holding groove 12 of the connecting housing 3. This portion of the blade holder 4 has recesses 25, 28 and 29 for the bolt head 9, the pinion and the fastening screw 23. A separation point 27 is formed between the recess 30 for the bolt head and the recess 28 for the pinion, in such a way that a spring with a spiral results. FIG. 8 shows the blade holder 4 as seen along a section line C-C of FIG. 7.

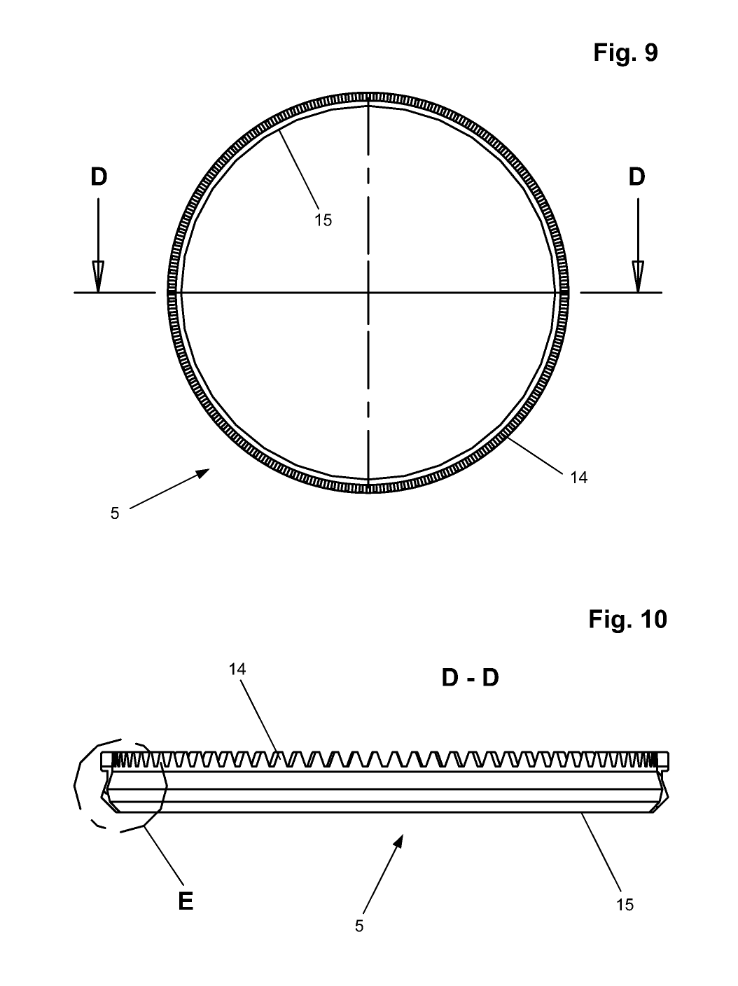

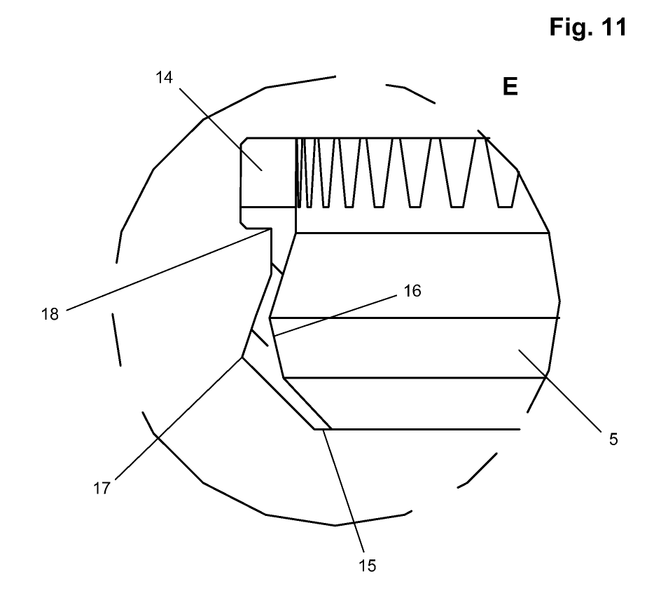

The blade 5, as shown in FIGS. 9 and 10, is implemented as a closed ring, which is equipped with the gear rim 14 on its outer periphery and with a cutting edge 15 on its inside. FIG. 10 shows the blade 5 as seen along a section line D-D of FIG. 9.

FIG. 11 shows an enlarged section of the blade 5, illustrating a portion E of FIG. 10, with the blade having a curved concave inner surface 16, on which the slaughter product is cut, and a convex outer surface 17, which forms the circumferential guiding groove 18 below the gear rim 14, through the use of which the blade 5 is maintained in the blade holder 4.

1. A quick-change system for blades of a meat trimmer used as a cutting tool in the stripping or cutting of meat and the like, the system comprising:
a handle with a connecting housing;
said connecting housing having two sides and arm-shaped projections each disposed at a respective one of said sides;
a ring-shaped blade holder attached to said connecting housing by mounting at said projections, said blade holder having a separation point between said projections;
a ring-shaped blade guided in said blade holder and driven to rotate; and
a releasable bolt having a head fixing said blade holder to one of said projections in an operating position of said blade holder;
said blade holder configured to be bent open from said operating position to a blade change position upon loosening said bolt, permitting said blade to be changed quickly without tools and without readjusting said blade holder after returning said blade holder to said operating position.

2. The quick-change system for blades according to claim 1, wherein said bolt head engages in a recess in said blade holder disposed near said separation point and having the same size as said bolt head.

3. The quick-change system for blades according to claim 1, wherein said bolt has an end with a thread opposite said bolt head, and a nut is screwed onto said thread for releasing said bolt.

4. The quick-change system for blades according to claim 1, wherein said bolt passes through an opening in said one projection, and a knurled nut is disposed on said bolt outside said connecting housing.

5. The quick-change system for blades according to claim 1, which further comprises a fastening screw fixing said blade holder at the other of said projections of said connecting housing, for allowing adjustment of a size of said operating position.

6. The quick-change system for blades according to claim 1, wherein said connecting housing has an inside with an inner holding groove in which said blade holder is held.

7. The quick-change system for blades according to claim 1, wherein said blade holder is formed of an elastic metal with elastic properties, permitting said blade holder to return to an original position.

8. The quick-change system for blades according to claim 1, wherein said blade holder has an inside with a circumferential guiding tongue and said blade has an outside with a circumferential groove, said tongue and said groove mutually engaging for guiding said blade in said blade holder.

9. The quick-change system for blades according to claim 1, wherein said blade has an outer periphery with a gear rim configured for engagement of a pinion for driving.

10. The quick-change system for blades according to claim 1, wherein said blade has an inside with a cutting edge.
